(19) United States
(12) Patent Application Publication
(10) Pub. No.: US 2010/0082410 A1
(43) Pub. Date: Apr. 1, 2010

(54) METHOD AND APPARATUS FOR A DATA PROCESSING SYSTEM

(76) Inventors: Catherine Baudin, Palo Alto, CA (US); Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/495,646

(22) Filed: Jun. 30, 2009

Related U.S. Application Data
(60) Provisional application No. 61/101,124, filed on Sep. 29, 2008.

(51) Int. Cl. G06Q 10/00; G06F 17/30; G06Q 30/00

(52) U.S. Cl. 705/10; 707/E17.014; 707/E17.017

(57) ABSTRACT

Methods, apparatus, and systems to determine a niche market of items or services, the first phase of which identifies a gap between demand and supply for a set of items. Session logs may be evaluated to compare transactions involving a specific item to those of a larger group of items. The resultant information identifies areas of high demand, but with low availability. The niche market information may be provided as direct merchandising items for sellers. In one example, the method generates niche market item web pages in specific categories. Additional methods, apparatus, and systems are disclosed.

### PRIORITY APPLICATION

This non-provisional patent application claims the benefit of the filing date of U.S. Provisional Patent Application No. 61/101,124, filed Sep. 29, 2008, entitled “MINING USER QUERIES AND TRANSACTIONS TO DISCOVER UNTAPPED NICHE MARKETS”, and assigned to the same assignee as the present Patent Application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2009 eBay Inc. All Rights Reserved.

### BACKGROUND

Electronic commerce provides a convenient mechanism for sellers and buyers to transact business. Communications are recorded and stored in databases and session logs. This information is accessed to determine the performance of products and advertisements, as well as the performance of sellers.

### BRIEF DESCRIPTION OF THE DRAWINGS

FIGS. 1 and 2 are block diagrams illustrating a system having a client-server architecture to provide image services, according to an example embodiment;

FIG. 3 illustrates a domain and category structure and organization in a data processing system, according to an example embodiment;

FIG. 4 is a block diagram illustrating a system and apparatus for implementing a niche market finder method, according to an example embodiment;

FIG. 5 illustrates a response generated by a niche market finder method, according to an example embodiment;

FIG. 6 is a flow diagram illustrating a gap analysis method, according to an example embodiment;

FIG. 7 is a flow diagram illustrating a query-item mapping method, according to an example embodiment;

FIG. 8 is a flow diagram illustrating a method for identifying a seller, according to an example embodiment;

FIG. 9 is a flow diagram illustrating a method for seller profiling and identifying a seller, according to an example embodiment;

FIG. 10 is a flow diagram illustrating a method for matching seller category structures to niche market category structures, according to an example embodiment;

FIGS. 11 to 13 illustrate identifying a niche market and identifying sellers for application of the niche market, according to example embodiments;

FIG. 14 is a block diagram of a computing device find niche markets, according to an example embodiment; and

FIG. 15 is a block diagram of a system to find niche markets, according to an example embodiment.

### DETAILED DESCRIPTION

In the following description, for purposes of explanation, numerous specific details are set forth in order to provide a thorough understanding of some example embodiments. It may be evident, however, to one of ordinary skill in the art that embodiments of the invention may be practiced without these specific details.

For services offered through a networked communication system, such as an on-line service offered over the Internet, suppliers of products and services coordinate with consumers. When a user accesses the service, they enter search terms to identify items. The suppliers attempt to predict demand, and evaluate product lines and services based on completed transactions. Many requests, however, go unfulfilled when there is an unknown or unrecognized demand for products and services that are not offered. That is, when niche markets are not identified.

Sellers seek to identify the next niche market to increase sales in new areas. Identification of niche markets may thus include considering items not generally associated with high frequency requests A seller or a buyer is an entity associated with a physical business or person that comprises a group of items that can be counted, bought, sold, and traded.

The following describes a method to identify niche markets or areas of a market which are undersold. A niche market may comprise a market segment where user demand is not currently satisfied. In addition to helping uncover untapped markets, the identified items making up the niche market may be used by sellers to expand their inventory and increase their sales. Similarly, niche market item information may be used to promote affiliated products.

A data processing system with a known inventory evaluates user demand by analyzing transactions. The analysis may consider search entries, click-through transactions, completed purchases, and related transactions. In such a system, information used for evaluation is known and maintained by the system. For example, single-vendor inventory has a known structure and merchant catalogue. Therefore, discovering user demand in relation to system supply is straightforward.

Attempting to analyze demand and supply relationships across multiple merchants or sellers in a less structured environment, such as a matrixed environment or a multiple-seller system with no universal product indexing scheme, is a more challenging task. One such environment is a multi-vendor data processing environment, such as the eBay® sales environment provided by eBay of San Jose, Calif. (CA). In one example embodiment, a multi-vendor data processing system identifies products and items by categories, wherein individual sellers provide detailed information to describe an item. The data processing system does not maintain precise structured inventory, but rather positions items within categories, where each category may include multiple items.

In an example embodiment, a method to identify niche market products or categories includes activities to retrieve data from the data processing system and transform the data into niche market information used to identify niche market products or categories. In one example, a method to determine a niche market includes two phases. The first phase is a gap analysis which identifies gaps and disconnects between demand and supply. The first phase analyzes user queries in session logs. The niche market determination further has a second phase of query-item mapping. In the second phase, candidate queries are used to identify corresponding niche market items. When candidate queries identify items which are in low supply, this may indicate the existence of a niche market. The result of the niche market determination may be provided to users in multiple formats, including web pages identifying lesser known niche market items for specific categories, and specific items that can be used for direct merchandising by sellers. In one example, the method includes activities to generate niche market item web pages in specific categories. The methods and apparatus described herein transform the sales data and other information into an indication of the existence of at least one niche market.

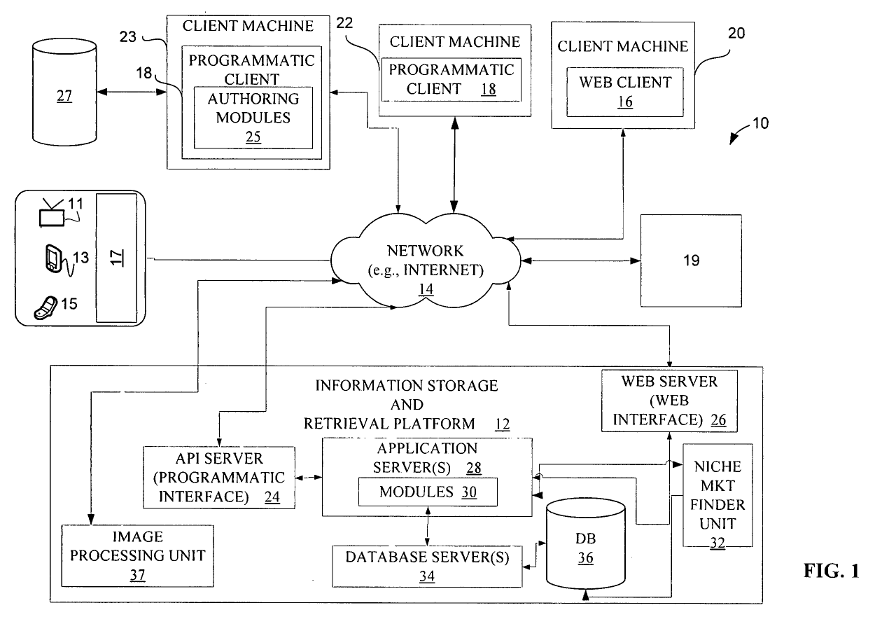

One example embodiment of a distributed network implementing image recognition services for identifying data items stored in an information resource is illustrated in the network diagram of FIG. 1, which is a block diagram illustrating a system 10 having a client-server architecture and for providing image services, according to an example embodiment. Within system 10, a commerce platform or commerce server includes an information storage and retrieval platform 12, which provides server-side functionality, via a network 14 (e.g., the Internet) to one or more clients. As illustrated, system 10 interacts with a web client 16 executing on a client machine 20, a programmatic client 18 executing on a client machine 22, and a programmatic client 18 in the form of authoring modules 25 executing on a client machine 23. In one embodiment, the web client 16 comprises a web browser, but may employ other types of web services.

Within the information storage and retrieval platform 12, Application Program Interface (API) server 24 and web server 26 are coupled to, and provide programmatic and web interface to, one or more application servers 28. Application servers 28 host one or more modules 30 (e.g., applications, engines, etc.). Application servers 28 are, in turn, shown to be coupled to one or more database servers 34 that facilitate access to one or more databases 36. Modules 30 provide a number of information storage and retrieval functions and services to users accessing the information storage and retrieval platform 12. A user accesses information storage and retrieval platform 12 through network 14.

While system 10 of FIG. 1 employs a client-server architecture, the present disclosure is not limited to this architecture, and could be applied to a distributed, or peer-to-peer, architecture system. The various modules 30 may also be implemented as stand-alone software programs, which do not necessarily have networking capabilities.

The web client 16 may access the various modules 30 via a web interface supported by web server 26. Web server 26 allows developers to build web pages. In one embodiment, web server 26 may be used in collaboration with JAVA® technologies by Sun Microsystems of Menlo Park, Calif., and with Ajax (Asynchronous JavaScript and XML) technologies, which comprises a collection of technologies enabling the creation of web applications. Ajax uses JavaScript, eXtensible Markup Language (XML), Cascading Style Sheet (CSS) formatting, along with other technologies. Ajax allows programmers to refresh certain parts of a web page without having to completely reload the page. By obtaining information dynamically, web pages load faster, respond more quickly to requests, and are more functional. Developers consider using Ajax applications, and Ajax-like applications, when seeking to reduce network latency in certain applications.

Similarly, programmatic client 18 accesses various services and functions provided by the modules 30 via the programmatic interface provided by the API server 24. In one example, programmatic client 18 comprises a seller application (e.g., the TURBOLISTER® application developed by eBay Inc., of San Jose, Calif.) enabling sellers to author and manage data item listings, with each listing corresponding to a product or products, on information storage and retrieval platform 12. Listings may be authored and modified in an off-line manner such as when a client machine 20, 22, or 23 is not necessarily connected to information storage and retrieval platform 12. Client machines 20, 22 and 23 are further to perform batch-mode communications between programmatic clients 18 and 25 and information storage and retrieval platform 12. In addition, programmatic client 18 and web client 16 may include authoring modules (not shown) to author, generate, analyze, and publish categorization rules used in information storage and retrieval platform 12 to structure data items and transform queries. In one example embodiment, transforming queries uses a data dictionary with token pairs to expand a narrow keyword or to focus a broad keyword. The client machine 23 is further shown to be coupled to one or more databases 27. The databases 27 include information used by client machine 23 in implementing a service or operation and may include specific information for products or services offered by client machine 23.

Users having access to service(s) provided by client machine 23, for example, include users of computer 19 and users of wireless network 17, which may serve as a common access point to network 14 for a variety of wireless devices, including, among others, a cable-type television service 11, a Personal Digital Assistant (PDA) 13, and a cellular phone 15.

In one example, client machine 23 enables web services, wherein a catalog of web services comprises information stored in the information storage and retrieval platform 12. Client machine 23 stores information related to use of the web services in databases 27, wherein the information may be used to identify associated services and offerings. The associated services and offerings are also listed in the catalog of web services. Descriptors of the associated services and offerings may be used to generate and modify a vocabulary for a data dictionary corresponding to the catalog of web services, such that a user search having keywords related to a first service may return results for a second service associated with the first service. Additionally, each of client machines 20, 22 and 23 may also be users that search data items in information storage and retrieval platform 12.

In another example, client machine 23 may be a data processing client offering products to customers via network 14. Client machine 23 stores a catalog of products in information storage and retrieval platform 12, with the catalog of products having a corresponding data dictionary. Client machine 23 stores information related to at least one product in databases 27. The information may include frequency of searches, resultant sales, related products, pricing information, and other information related to customer use of the data processing service. Additionally, databases 27 may store other product-related information, such as style, color, format, and so forth. Client machine 23 may use the information stored in databases 27 to develop descriptor information for at least one product. Product descriptors and other product information may be used to generate and modify a vocabulary for a data dictionary corresponding to the catalog of products, such that a user search having keywords related to a first product may return results for a second product associated with the first service. In other embodiments, a client machine, such as client machines 23, 22 and 20, may store information in the information and storage retrieval platform 12 related to business processes, or other applications which store data in a database which may be accessed by multiple users. A common problem in such systems is the ability to understand and anticipate multiple users' keywords entered in search queries as search terms. Each of the multiple users may use different keywords to search for the same data item. The use of a data dictionary corresponding to data items enhances a search mechanism in returning the same data item to different users resulting from searches on different keywords.

To facilitate searches within information storage and retrieval platform 12, image processing unit 37 provides image processing services, including image recognition of data received from a client machine and image compression processing. The image processing unit 37 may operate on information received from client machines 20, 22, and 23, such as product or service descriptor information, as well as other information related thereto. Image processing unit 37 processes this information to compare received information with stored data for items, such as barcode information of an item or a photograph or other image found outside of system 10. The image processing unit 37 may further provide data compression to reduce the size of received information to facilitate storage, further processing, and transfer of information to another entity. The image processing unit 37 also aids in searching data items stored in databases 36, by matching the received information to known data. Such comparison and matching may use any of a variety of techniques. Further, the received information may be similar to search query information, which is traditionally entered as textual information or by selection of categories presented to a user. The image processing unit 37 allows the system 10 to handle image-based queries.

In one embodiment, the received image information corresponds to data item information (e.g., product information). In addition, the received image information may correspond to non-specific items, such as to a category of items, which are identified and then presented to the requester.

Where the quality of a search mechanism (e.g., a search engine) to search an information resource is measured by the ability to return search results of interest to the user (e.g., search requester) in response to a search query, image processing unit 37 dramatically expands the type of information and specificity of information a requester may submit as the subject of a search. For example, a search mechanism may respond to a query from a user with search results that contain data items covering a spectrum wider than the interests of the user. Traditionally, the user may then experiment by adding additional constraints (e.g., keywords, categories, etc.) to the query to narrow the number of data items in the search results; however, such experimentation may be time consuming and frustrate the user. To this end, the use of image information in many cases provides an exact, and often unique, identification of the desired item.

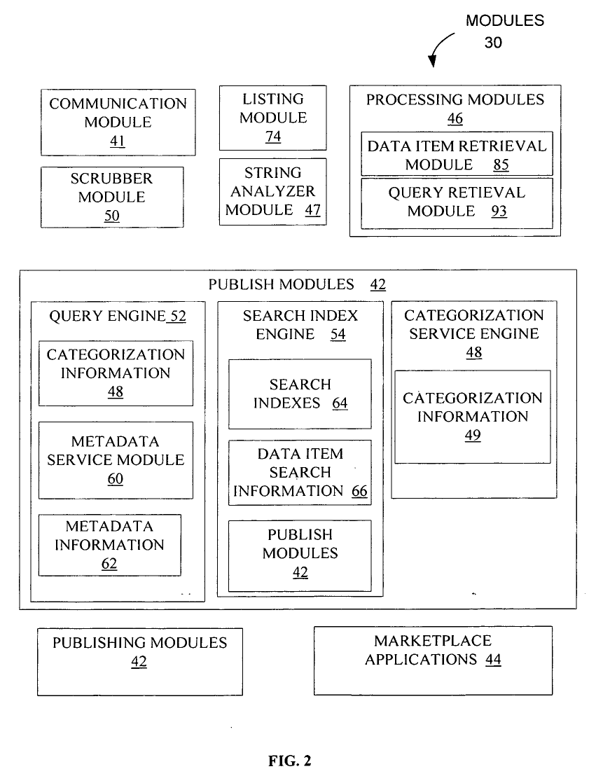

Continuing with system 10 of FIG. 1, information storage and retrieval platform 12 includes modules 30 within application server(s) 28, wherein modules 30 is further detailed in FIG. 2. Similar to the illustration of FIG. 1, FIG. 2 is a block diagram illustrating modules 30 within system 10 according to an example embodiment. The modules 30 may include software modules or the functionality of a module implemented at least partially in software. The software may be developed using a programming language, such as JAVA, which is an object-oriented programming language developed by Sun Microsystems. Other languages and development tools may be used according to the design and purpose and at the discretion of the system developer.

Modules 30 are to receive images and other information from entities within system 10, such as through network 14 (see FIG. 1). Further modules 30 comprises a communication module 41, to receive, process and transmit messages according to one or multiple communication protocols.

Hypertext Transfer Protocol (HTTP) is used to publish and retrieve text pages on the Internet. HTTP now allows users to generate numerous requests to perform a wide variety of tasks. For instance, it is possible to generate a request to obtain the meta-information of some file located on a remote server. The two fundamental request types of HTTP are GET and POST. The GET request encodes data into a Uniform Resource Locator (URL), while a POST request appears in a message body. The URL identifies a location of a participant in an HTTP communication. Typically GET requests involve retrieving or “getting” data, and a POST request is not so limited, applying to storing data, updating data, sending an email, and ordering a product or service. In one example, communication module 41 processes GET-POST messages.

GET requests embed the parameters of requests in the URL as parameter-value pairs. An example of the resulting URL when parameters for a specific name and zip-code are embedded is provided as:

HTTP://www.site.com/get.cgi?name=John&zip=012345.

POST requests require additional space in the request itself to encode the parameters. The additional space is well used when a large number of parameters or the values are desired or required, but such a large number of parameters may be too voluminous to be embedded directly into a URL. For example, a POST request is used when transferring contents of a file from a browser to a server.

The tools 50 provide developer tools and software for building applications, such as to expand or enhance the image processing capabilities. In one example, tools 50 include Java servlets or other programs to run on a server. As the present example implements Java tools, some terms used with respect to Java applications and tools are detailed. A Java applet is a small program sent as a separate file along with an HTML communication, such as a web page. Java applets are often intended to run on a client machine and enable services. Java applet services, for example, may perform calculations, position an image in response to user interaction, process data, and so forth.

In a networked computing system, some applications and programs are resident at a central server, including those enabling access to databases based on user input from client machines. Typically, such applications and programs are implemented using a Common Gateway Interface (CGI) application. When Java applications are running on the server, however, these applications and programs (i.e., Java servlets) may be built using Java programming language. Java servlets are particularly useful when handling large amounts of data and heavy data traffic, as they tend to execute more quickly than CGI applications. Rather than invoking a separate process, each user request may be invoked as a “thread” in a single process, or daemon, reducing the amount of system overhead for each request.

Instead of a URL to designate the name of a CGI application, a request to call a Java servlet may be given as:

HTTP://www.whatis.com:8080/servlet/gotoUrl?HTTP://www.someplace.com

wherein the characters “8080” designate a port number in the URL that operates to send the request directly to the web server. The “servlet” indication within the URL indicates to the web server that a servlet is requested.

Java servlet technology enables developers to generate web content on the fly. For example, an Apache Tomcat™ application server may be used to deploy and test Java servlets. Application server(s) 28 wait for HTTP requests and run appropriate portions of Java servlets responsible for handling GET or POST requests as received. Java methods generate responses, which are in turn transferred by application server(s) 28 to a client using HTTP communications. The responses generally consist of plain text data, using HTML or XML tags, but may be used to transfer non-plain text files such as images and archives.

XML is a markup language allowing a user to define custom tags to describe data in many domains. It is used to exchange information across different systems via the Internet. XML documents are used for the structure, storage, and transportation of various types of data.

An XML element contains a start and end tag, and all of the information contained within, which can be either more XML elements or text data. The following is an example of an XML document:

```
<?xml version=”1.0”?>
    <Staff>
        <Employee>
            <Name> John</Name>
            <Salary>1000</Salary>
        </Employee>
        <Employee>
            <Name> Mike</Name>
            <Salary>5000</Salary>
        </Employee>
    </Staff>
```

wherein the <Staff> element contains two employee elements, and each <Employee> tag contains various descriptions of each employee, including his name and salary, contained in the <Name> and <Salary> tags. In this example, an XML file may be used to store and transport information on the staff of a company.

Other tools include various development applications. In one example, an Integrated Development Environment (IDE), such as Eclipse® environment provided by the Apache Software Foundation, can be used to develop Java software. Additionally, plug-ins may be written for the Eclipse platform to expand development capabilities and allow the use of other programming languages.

As illustrated in FIG. 1, the information storage and retrieval platform 12 further includes a niche market finder unit 32, which in one embodiment includes instructions for executing a method for identifying niche markets by analyzing query logs, keywords, and transactions to identify gaps between the supply catalogues and demand for products. Once identified, query profiles are built and used to identify a metacategory which identifies a niche market.

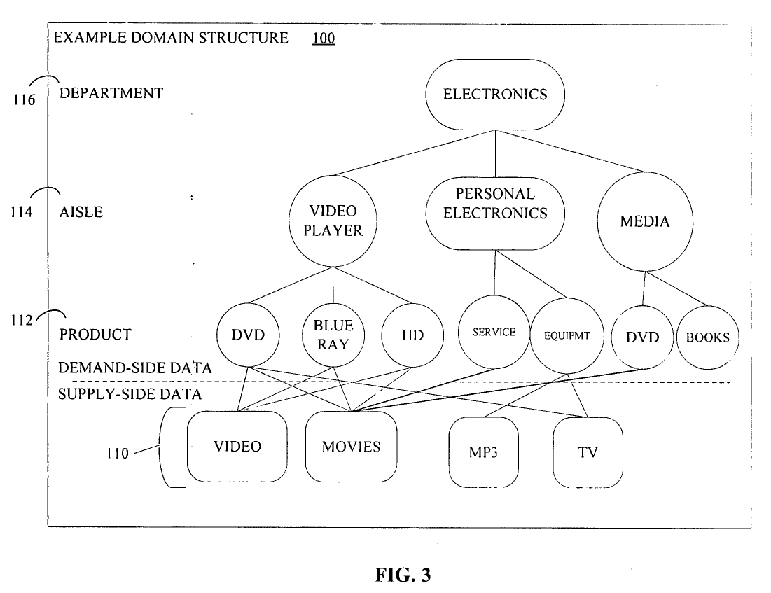

An example embodiment seeks to identify queries related to a given category that map to a set of items in reasonably high demand and in low supply. FIG. 3 illustrates a domain and category structure and organization in a electronic data processing system, according to an example embodiment, which may be used to identify a missing niche market. As illustrated, an example domain structure 100, according to one embodiment, includes demand-side data, and supply-side data. The supply-side data is shown to include categories 110 that may have been selected by an author (e.g., the seller or supplier) of an item which is categorized by the information storage and retrieval platform 12. For example, the author may select one or more categories 110 including video, movies, MP3, or TV, to describe the item. The demand-side data includes the product domains 112 (e.g., DVD, Blue Ray, and so forth), an aisle domains 114 (e.g., video player, personal electronics, or media) and a department domain 116 (e.g., Electronics). Various domain rules may be used to associate supply-side data or categories to the demand-side data, such as product, aisle and department domains 112, 114, 116.

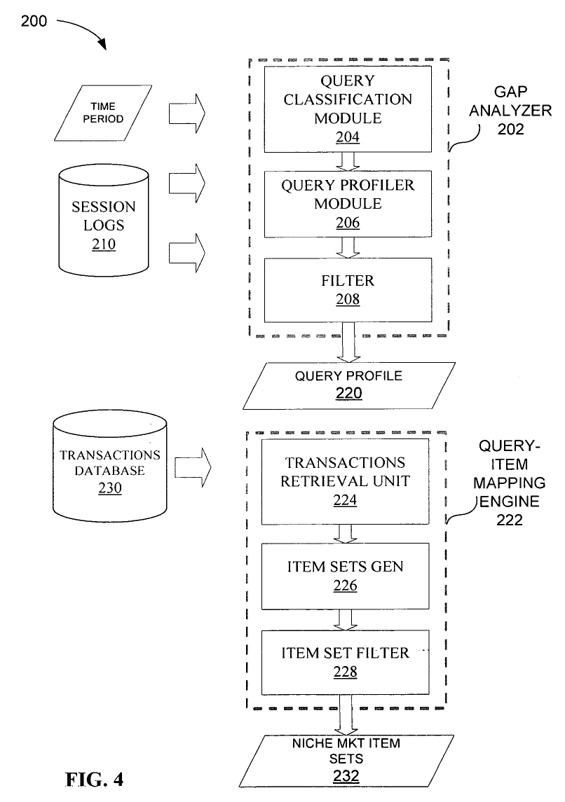

The niche market finder unit 32 of FIG. 1 may further be described as in FIG. 4, which is a block diagram illustrating a system 200 and apparatus for implementing a niche market finder method, according to an example embodiment. As in FIG. 4, a system 200 includes two phases, a gap analysis phase performed by gap analyzer 202, which generates a query profile 220, and a query-item matching phase performed by query-item (QI) mapping engine 222, to generate an indication of a niche market.

In one embodiment, a method includes activities to extend analysis of null queries to identify untapped markets. The queries are analyzed according to a triplet of information contained in each query, the information comprising: i) the query string, ii) a category or metacategory, and iii) an analysis time period. As a result of the method, a query profile 220 is built for each query unit. The gap analyzer 202 creates each query profile 220 by creating a set of features including:
1. Query unit profile for a given time period, such as a one day average, and for a given category,
2. Query string, identifying the query entered for search by a consumer,
3. Category, which may be determined from a product domain organizational structure,
4. #GUIDs, which comprises a measure of query frequency, and which may be measured as an average number of Global Unique ID (GUIDs) that contain the query in the category,
5. #Sessions within the given time period, which may include sessions within and outside a given category,
6. #Results returned, such as the number of results returned for the current query in the associated category,
7. #Bids/BINs, such as the number of bids or Buy-It-Now (BIN) transactions that follow the query, wherein a bid is considered during the same session as the query and directly following the query without intervening queries so as to assure the causal relationship of the bids,
8. Conversion rate, which may be calculated as the number of sessions per number of bids or bins, i.e., [#Sessions]/[#Bids/BIN], and
9. Demand/Supply ratio, which may be calculated as the number of results returned per query frequency, i.e., [#Results]/[#GUIDs].

In the gap analyzer 202, according to an example embodiment, another feature is measured to identify a level of interest in a product, wherein the feature is calculated as:

Interestingness[Qi]=f(Demand_supply ratio[Qi],Conversion_Rate[Qi],#GUIDs[Qi]) Equation (1).

As used in the example formulation, a GUID is a special type of identifier used in software applications as a reference number which is unique in any context, and thus is referred to as a global reference. Alternate embodiments may implement other types of identifiers.

As used throughout this discussion, a session or a user session stands for a set of activities performed in response to inputs, such as from a user, during a single block of time during which a connection is maintained with the networked system and during which inputs continue to be received; a networked system may include an online system. In an example situation, a session is defined as starting when a login indication or entry is received in a system, continues during use of the system and terminates when a logoff is initiated or completed. Often a user will not log off an online system, as they merely close their browsers or move away to other services, so a session may be defined to terminate after a certain period of inactivity on the subject online system or application.

As used throughout this discussion, a Buy-It-Now (BIN) option may be available in an electronic data processing system. A BIN or an auction bid is a purchase transaction; for a BIN event a purchase is completed and the item consumed, and for an auction bid the purchase may be completed or the bid may fail. In one example, BIN refers to the option in the EBAY system, wherein listed items for auction are available to prospective buyers for direct purchase at a fixed revealed price. Using the BIN option, a buyer is able to circumvent the normal auction processing and purchase the product without waiting for the auction to complete.

The gap analyzer 202 acts as a query profiling engine to associate a query with one or more categories. A query-to-category association may be performed in a variety of ways, including combining the results of multiple approaches. According to one embodiment, a query classification method includes activities to consider a query sequence, including those events which occur after the query is entered and results are returned. To verify the causal relationship between the query entry, returned values and subsequent transaction, the method includes considering those sequence events within a same session. For example, after a query submission and return of results, a user may continue to view an item or enter a bid. Alternate actions may result in the user monitoring an item. The method includes considering related actions also within the target category, such as viewing an item that is related to an item returned in response to the query. An alternate method includes activities to seek to simplify the process considers a constrained set of search events, such as results to a GetResult instruction to retrieve results of an action or request, or other actions performed within a given category. As this is a more simplistic approach, the resultant calculations and query profiles result from only a portion of a total number of searches performed, and therefore, may underestimate the volume of the demand for specific items. Such an approach may prove beneficial in determining an approximation of demand with respect to meta-categories, such as those at the top of a category hierarchy.

As illustrated in FIG. 4, the gap analyzer 202 includes a query classification module 204, a query profiler module 206, and a filter 208. The query classification module 204 selects a set of queries related to a given category. The query profiler module 206 then computes different feature values for each selected query. In one embodiment, numerical calculations, such as the conversion rates, are calculated as averages over a period of time, such as over one day or week. The query profiler module 206 then provides the feature values to filter 208, which determines which queries are of interest in determining a niche market. The filter 208 selects “interesting queries” based on the values in the query profile. The “interestingness” of the query is estimated as a function of the query frequency, such as given by the #GUIDs, a demand/supply ratio, and a conversion rate. The use of a conversion rate as one of the filter criteria helps the filter 208 to filter out those queries which are not strongly associated to a set of niche market items, and also helps to filter out those queries which may not be profitable. The filter 208 then provides a query profile 220 to represent a query or a set of queries which satisfy criteria as to a minimum frequency, a maximum demand/supply ratio and a minimum conversion rate. In other words, the query profile 220 identifies candidates having a high probability of success as a niche market. These are items or categories which have a high unsatisfied demand coupled with a low supply or supplier interest. These results are particularly valuable to sellers or suppliers in an electronic data processing marketplace. The ability for a market place service provider to supply a seller with such guidance enhances the market place's transactions and reputation, increases the seller's performance and reputation, and increases the satisfaction of consumers.

As illustrated, the gap analyzer 202 receives time period selection and information, which determines the period over which information and data is to be analyzed. Similarly, session logs 210 provides the query and response data as well as follow on transactions and other related events, such as further search, monitoring, viewing, bidding, purchasing, and so forth.

Continuing with FIG. 4, the query-item mapping engine 222 uses the query profile 220 to evaluate transactions specifically to select queries of interest, which are queries having a query profile that may signal a low demand-to-supply ratio for a product. On selection of a query as being of interest, the query-item mapping engine 222 seeks to match the selected queries to a corresponding set of products. The products are to be identified as suggested niche market items. The query-item mapping engine 222 retrieves completed transactions, such as a sample set of transactions, from the transactions database 230.

According to one embodiment, a method includes analyzing a set of structured attributes associated with completed transactions. Such attributes may be related to item price, item quantity and item condition, such as used or new. As part of the processing, each item set is separated into subsets of items, such as according to similar price ranges. The price range may be specified as a percentage plus or minus of an average price. Similar ranges may be applied to quantitative values for quantity, condition, and so forth. The sales ratio may then be recomputed, wherein each subset of items that passes a threshold is then separated from the initial group and becomes a new niche market item set.

The query-item mapping engine 222 then computes a global success ratio as follows:

Global ratio=[#of items sold]/[# total transactions]. Equation (2)

If the global sales ratio is less than a threshold, the query-item mapping engine 222 tries to identify a subset of similar items with a success ratio that satisfies or exceeds the threshold. Thresholds may be determined in various ways, such as by trial and experimentation on sample queries. Similarly, thresholds may be determined for specific criteria used for an application in order for a query to return a specific number of items. The threshold value may be a fixed value, or may be dynamic. In one embodiment, a threshold is a function intended to result in a minimum or maximum number of items. Various embodiments may incorporate feedback to periodically adjust or correct thresholds to avoid degeneration and to improve performance.

In an example embodiment, the subset of similar items is made of the items classified under the same category leaf. In this context, leaves are categories under a same metacategory. As illustrated in FIG. 3, domains 112 and categories 110 are examples of leaf categories, while a metacategory is shown by example using the department domain 116. Transactions in the same leaves are grouped together, wherein they may be ordered according to a feature or specification, such as size. Returning to FIG. 4, when the system 200 is able to build such a subset having a sufficient number of items and a satisfactory sales ratio, a niche market item set is created within the leaf category rather than in the initial target category.

The query-item mapping engine 222 includes a transactions retrieval unit 224 for interacting with transactions database 230. The transactions retrieval unit 224 may access the transaction data directly, or by using a messaging protocol to retrieve information. Further, an item sets generator 226 is used to determine the subset of similar items. The item set filter 228 filters the subsets to provide a set of items satisfying specific criteria, such as to include a predetermined number of items and satisfying a satisfactory sales ratio.

The query-item mapping engine 222 then outputs a collection of niche market item sets 232 having the following characteristics:
niche market item set<Query, Category, MaxItemSetSize, Success_ratio, AvrPrice, {Itemid1 . . . Itemidn}, {title1, . . . titlen}>.

The output of query-item mapping engine 222 may then be used in a variety of different ways and for a variety of purposes. The niche market item sets 232 may be used by an e-commerce business to develop new markets and product lines. Further, this information may be used to build complementary and accessory lines for a current inventory. Additionally, sellers may identify these markets earlier than competitors.

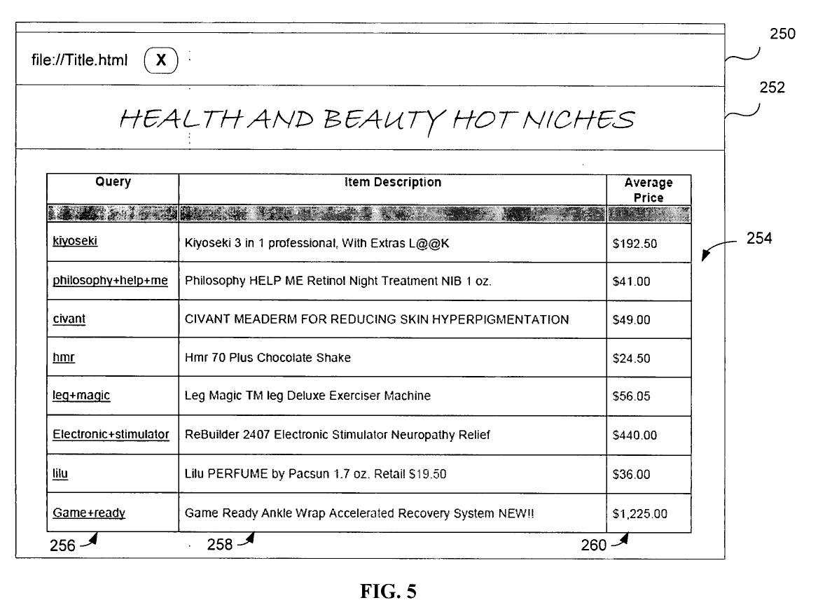

In one example, a service is provided on a web page for a “Niche Finder” where a user may specify a target category and the service will find new niche markets or niche market item sets. An example embodiment is illustrated in FIG. 5 as a response generated by a niche market finder method. For each niche market finder item having an average price over a minimum threshold, a correspondence is generated between the item and user entered search queries in the specified category. Under the query, the title of one representative item is displayed along with an average price for this set.

As illustrated in FIG. 5, an example of a niche market finder page 250 is illustrated for the category entitled “Health And Beauty Hot Niches.” The niche market finder page 250 includes a header section 252 to identify the specific niche market found, and a listing of query terms with a sample product description and an average price. The page 250 further presents the listings in a tabular form, with query column 256, item description column 258 and average price column 260. Each listing corresponds to one query term or query string, such as illustrated in the first row of the table 254 where the query term is “kiyoseki.” This term corresponds to the entry by consumers seeking a product or item. In response to the query, items were found, including a representative item described as “Kiyoseki 3 in 1 Professional With Extras L@@K . . . .” The item description column 258 provides detailed information for this result, as returned for the query “kiyoseki.” Additionally, the table 254 also details the corresponding average price for results to the query in the average price column 260, which, for the query “kiyoseki,” is given as “$192.50.” The average price is not necessarily the price of the representative item, but in this example is the average of the set of items returned in response to the query. Alternate presentation formats may be used to identify the niche markets. Similarly, additional information may be included in such presentations, such as statistics on the total number of products returned in response to the query, further details related to the individual products returned, range of pricing, or other information.

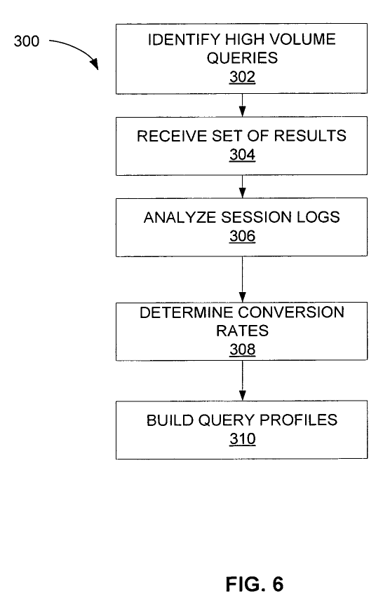

To generate the niche market finder information, the method includes first building query profiles, and then maps these to items. Such processing is further illustrated in FIGS. 6-8, as described in more detail below. As a high-level example, consider that a computer-implemented method can be used for processing data in an electronic data processing system. The electronic data processing system receives a first number of search queries made up of at least one search term. In response, the system generates a second number of search results, each corresponding to an item assigned to a category of the electronic data processing system.

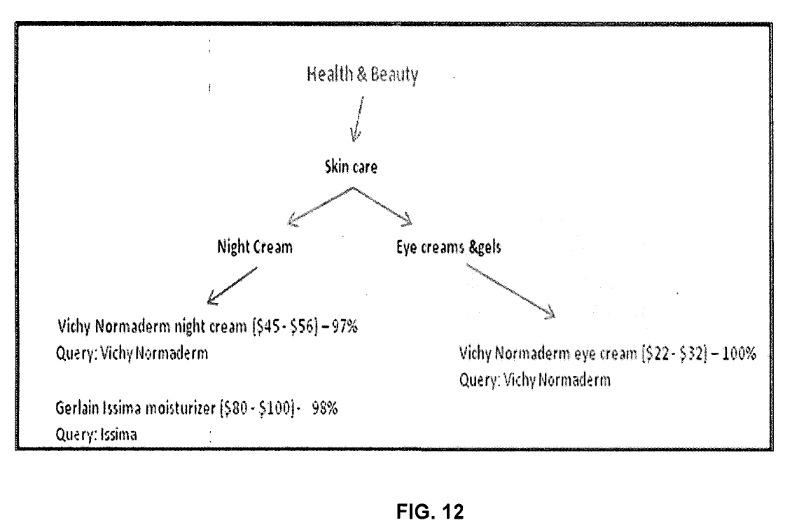

The electronic data processing system may implement inventory in a hierarchical database, such as illustrated in FIG. 3 or 12, wherein products or items are organized according to categories starting with a metacategory, which is a parent category having several subcategories or leaf categories. In FIG. 3, for example, electronics is a metacategory, having subcategories of video player, personal electronics, and media. The subcategories may be considered children of the parent category, video player is a child of electronics. The method includes then selecting an evaluation item of the second number of search results, wherein the evaluation item is assigned to a first category. The selection is based on a ratio of the first number of search queries to the second number of search results. The method further includes calculating a sales ratio for sales of the at least one item and other items in the category over a first time period, and then selects a first set of items in the first category having a sales ratio satisfying a sales ratio threshold. In this example, the first number corresponds to demand for corresponding items and the second number corresponds to supply of the corresponding items.

According to one example, a ratio of the first number of search queries to the second number of search results reflects a supply-to-demand gap. In other words, the search queries are high for a given item, but the item is in low supply, having low availability. This may indicate a potential niche market. Some embodiments may extend the potential niche market by looking at items which are in categories proximate to the items identified as in a potential niche market. Similarly, some embodiments may identify a second set of items related to the first set of items. For example, if the first set of items includes shoes, the second set of items may be shoe laces, or belts.

Such methods further include seeking information to evaluate user activity. For example, in an electronic data processing system, session logs may be maintained to record the computing session. When a user logs onto the system, or accesses the system via the Internet, a computing session is initiated. The computing session then records receipt of search queries, and follows transactions thereafter. The session is recorded in a session log. The session log may include click-through activities, where the user selects a link presented in response to the query search, and may include completed transactions, such as purchase or bid entries. The electronic data processing system may be an auction-based system to interface sellers and buyers.

The methods for finding niche markets may also implement measures and criteria specific to the electronic data processing system, seller to buyer. For example, a niche market finding method may include searching session logs to identify search queries having a measured value, such as frequency, in order to identify the demand. In another example, the niche market finding method may include evaluating pricing of items. The measured value or criteria may be evaluated with respect to a threshold value. The specific measurement or criteria used may also be dynamically adjusted, such as to change a threshold value.

In another example, a method includes activities to first profile the queries in the metacategory, such as “Health & Beauty products,” and then select a query for specific brands of these products, such as the brand “Vichy,” when queries submitted satisfy a criteria, such as a minimum number of queries received or queries within a specified time period. The number of users may be approximated by the number of unique identifiers associated with the query. Similarly, the method includes considering whether the number of results returned by the selected query is less than a filter threshold applied to the profiling method. In this way, the method includes determining that the query is not overly general and will not include an unmanageable number of items. Further, the method further includes identifying those items having a conversion rate within a predetermined range of values. In other words, the number of purchases or bids following each query event involving that item, as indicated by the session logs, corresponds to a “desirability” potential for that item specific to the system or service.

Continuing with the present example of Health & Beauty products, query-item mapping within a system involves retrieving a sample of completed transactions for items containing the name Vichy in their title, within the Health & Beauty metacategory. The items are then grouped according the leaf categories. The sales ratios for these items are computed as ratios of a number of successful transactions to total transactions in each group of items. Completed items are retrieved, for example, in the categories including “day creams,” “night creams,” “eye & gel,” and “cleansing products.” Once the various ratios are computed for each category, some categories, such as day creams, pass the filtering threshold and therefore a niche market item is created with the query term Vichy in the category of day creams using the retrieved samples. Categories which do not pass the filtering threshold include those having lower conversion rates or sales transactions. In one example, only approximately 60% of night cream transactions were successfully completed.

A keyword extraction method may then be implemented to analyze successful and unsuccessful transactions. In one example, the keyword extraction method includes identifying a keyword “Normaderm” for addition to the original query “Vichy” with an expected high sales rate. The method may further include activities to group items having comparable prices, wherein items of different price ranges are grouped in separate niche market item sets. For example, the Vichy Normaderm item set may be separated into two niche market item sets: one for Vichy Normaderm with a price range of [$45-$56] and comparable quantities (night creams); and another one for Vichy Normaderm with a price range of [$22-$32].

The resulting niche market items are provided as an output, and may be used in a variety of ways to aid sellers in offering expansion. In one example, a graphic user interface is provided as a web page entitled “Niche Finder,” which is generated for a target category. In one embodiment, the Niche Finder presents a graphic display where for each niche market item having an average price over a minimum threshold price a line is generated relating the item to user entered real time search queries in the specified category. Under the query, the title of one representative item is displayed along with an average price for this set. In the current example, the query retrieves the auction formats. The results are sorted by decreasing sales ratios and filtered so that only items that sell at a minimum price are displayed.

FIG. 6 is a flow diagram illustrating a gap analysis method 300, according to an example embodiment, wherein method 300 corresponds to the operation of gap analyzer 202. The process first identifies at 302 high volume queries, or those queries having a frequency of occurrence over a threshold value. The determination of a high frequency may be established as a fixed number of queries received for a given time period, or may be calculated in relation to other statistics, for example, the frequency of a specific query being compared to the frequency of all queries. In another example, the frequency of a specific query is compared to the frequency of a related query. Alternate methods for determination of high frequency queries are also contemplated and may be specific to business goals or targets.

The method 300 then includes receiving, at 304, a set of results resulting from the query. In addition, the method 300 then analyzes, at 306, the session logs to extract information relating to the query and subsequent actions and events. For example, the session log records activities occurring during an electronic data processing session. The session log therefore records the submission of a query term, the resultant products, items and information returned, as well as follow-up information, such as click-through data, confirmed purchases, entered bids, selection of further view options related to the returned results, and so forth. Similarly, the session log may also record other queries submitted during the session to identify any related queries or items. This information may then be used to identify similar items, products and markets in identifying new niches markets.

Continuing with FIG. 6, the method 300 then includes determining, at 308, conversion rates as described hereinabove, and builds, at 310, query profiles. The query profile format may include a variety of features and measurements, which in some examples are specific to the business.

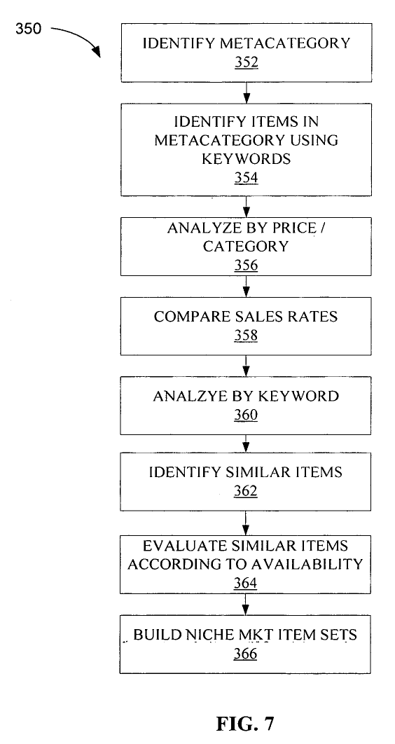

FIG. 7 is a flow diagram illustrating a query-item mapping method 350, according to an example embodiment. The method 350 corresponds to query-item mapping engine 222. The method 350 includes identifying, at 352, a metacategory as indicated by the query profile, by which transactions may be evaluated and considered to identify items and products. The method 350 then includes identifying, at 354, items in the metacategory using keywords. The metacategory may be used to identify a group of sellers to target with the niche market information resulting from the methods 300 and 350. The method 350 then includes analyzing, at 356, the items by price and category. The items are placed in a category hierarchy consistent with the domain structure of FIG. 3. The query-item mapping engine 222 continues to compare, at 358, sales rates for the items, wherein the sales ratio for an item is a measure of the number of that item sold to the total number of the completed items. The process continues at 360 to analyze the sales ratios corresponding to keywords, and, at 362, identifies similar items or related items of the same leaf category and in the same price range. The similar items are then evaluated at 364 according to availability, from which niche market item sets are built at 366.

In one example of the method 350, the sales ratio identifies the label “Chanel” as a brand within a category for perfume. Similar items associated with the same brand are identified to include lipstick, handbags, belts and accessories. The method 350 is used to identify which of these similar items have a demand higher than their supply. In other words, buyers often request or look for these items, but sellers do not supply sufficient items to meet demand, and therefore, the items are often unavailable and not returned in response to a query. The method 350 also includes considering the keywords in the title of the item. In the present example, the keywords include “Chanel” and “perfume”. At this point the items identified by these keywords are filtered to remove those items which do not have the sufficient demand-to-supply ratio for a niche market item. The method 350 then includes identifying those items which have low availability with high demand, and thus filters out those items which are not consistent with these criteria for niche market items. For example, the perfume Chanel No. 5 has a high demand with low availability, but Chanel No. 12 has low demand. The result is a niche market set of items for health and beauty products.

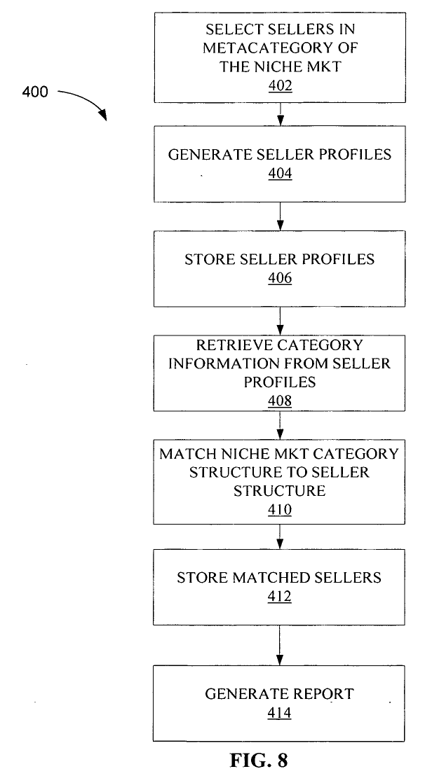

FIG. 8 is a flow diagram illustrating a method which further details a general method 400 for identifying a group of sellers to benefit from identification of the niche market. At 402, the method 400 includes activities to select sellers in the meta-category of the identified niche market, which was generated by the query-item mapping engine 222 of FIG. 4, and detailed in the processes of FIGS. 6 and 7. The method 400 then includes generating, at 404, seller profiles for each seller in the metacategory. In one embodiment, the method 400 includes generating seller profiles for a select group of sellers in the metacategory. Seller profiles are then stored, at 406, in memory storage for later analysis and use in identifying specific sellers for a specific niche market. The seller profiles include a variety of information which may be used for historic analysis. The process 400 then retrieves, at 408, category structure information from the seller profiles. A category structure corresponds to an organization of parent and leaf nodes on the domain structure or tree. The seller category structure is then matched, at 410, to the niche market category structure. The method 400 then includes activities to store, at 412, the matched sellers in memory storage. To match seller category structures to that of the niche market may further include comparing each seller with respect to certain qualifications, such as environmentally friendly products. The method 400 then includes generating at 414 a report, which may be used proactively to advise sellers, such as a recommendation provided to sellers of a system. The report may be pushed to sellers, for example, sent by email to selected sellers according to one embodiment. In another example, the report is generated in response to a request from a seller or potential seller, where the seller pulls the information.

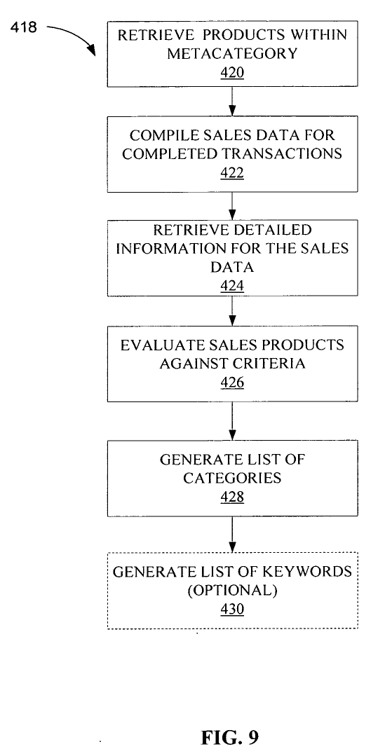

FIG. 9 illustrates a flow diagram of a method 418 for a seller profiling in identifying a seller according to an example embodiment. The method 418 may be used to build a seller profile, resulting in a list of categories, and optionally, a list of keywords. The method 418 includes activities to retrieve at 420 products within the metacategory of the niche market. For the products, the method 418 includes compiling at 422 sales data for completed transactions. The method 418 then includes retrieving at 424 detailed information associated with the sales data. For an electronic data processing system, the sales data may include the number of offers, completed sales, or other information related to the sale, such as length of time for sale and amount of money or other resource for advertising, wherein the advertising resources correspond to exposure of a product. In an electronic data processing auction system, the sales data may include the number of bids, analysis of the bid activity and average of the bid values. In the auction system, the sales data may be analyzed to identify anomalies, such as where a few buyers bid on a price that is not expected or usual. The sales data is used to determine high demand with low supply or low activity.

The method 418 then includes evaluating at 426 the sales products against criteria. From the sales data and evaluation, the method 418 then includes generating at 428 a list of categories, and optionally, at 430, a list of keywords.

In one embodiment, a list of keywords is generated by extracting keywords from the item titles for completed transactions. The process is similar to that used for keyword extraction to identify niche markets. The keywords and the categories may be applied as a part of the seller structure, wherein the keywords associated with a seller are used to match a seller structure to the niche market structure. The keywords assist in prioritizing a recommendation list generated for the seller.

Additionally, the keywords allow association of more distant categories to recommend additional niche markets, where distance refers to the number of connections in a tree structure or domain organization between two individual items or categories. For example, in FIG. 3, the “TV” category is part of categories 110, and is “close” to the “MP3” category, which is also part of categories 110, as both “TV” and MP3” categories are within the metacategory “equipment.” The TV category is “far” from the “video” category of categories 110, as the first common metacategory is the department 116 of “electronics,” which is three levels up the domain structure 100. Similarly, the video category is also three levels below the electronics of department 116.

As an example, a seller may offer a nutritional supplement called “slimshots” for sale. The niche market associated with the query “slimshot vanilla bar” and “slimshot chocolate” may be recommended to the seller as popular products which are in short supply. The process may first check if the recommendation is already a part of the seller's profile, and if not, will add the recommendation to the seller's profile. In various applications, keyword-based matching may be applied even in domains where the category structure is incomplete.

According to one embodiment, keyword extraction is used to identify niche market items by adding keywords to an original query. This is in contrast to restricting analysis to a category associated with items as in a category-based analysis. For keyword extraction, an item set engine analyzes the categories and titles of completed transactions to identify a word, a set of words, phrase, string, or other term for addition to a query. The titles may be tokenized in individual tokens, such as words or sequences of words. The words may be extracted through any of a variety of phrase extraction techniques, including conventional phrase extraction techniques applied to search queries and processes. A weight is computed and applied to each token, wherein the weight identifies the significance of the token in identifying a niche market and applying this information to sellers. In one embodiment, a frequency-based weighting method is implemented. The weight of a token represents its specificity across all items in a target metacategory, such as Health & Beauty in some of the previously described examples. The weight is also used to filter out general words that may prove as not descriptive of products or that span a broad range of categories, negating the niche market evaluation.

The tokens may then be sorted according to various criteria, including sales ratio and the size of the item set. In one example, the tokens are sorted in a decreasing order, according to the significance of the relationship. For example, the first listed tokens are expected to have the greatest correlation with an identified item, such as where tokens are listed first, corresponding to a high sales ratio or associated with pricing. Each token is then added to the original query and matched to item titles according to the sort order. For example, if a token is closely related to a specific item, that token will effectively be weighted to give that token a preference for addition to the original query. In this way the method recreates keywords or phrases for queries using weighted tokens.

In one example, an original query may have included the keyword “foundation” to search for products in a “cosmetic” category. The keyword extraction process may identify the token “beige” with a high weight as related to a specific product. The token “beige” will be added to the keyword “foundation” to result in a query of “beige foundation.” The methods and techniques described herein are provided as an example of keyword extraction, but other techniques may be applied as part of processed for identifying and applying niche markets. In one embodiment, the items with titles matching the token are then added to the item set and become part of a new niche market item set. According to one embodiment, an item may be restricted to inclusion uniquely in one item set. Some examples provide for different treatment of items depending on category, description, or other criteria.

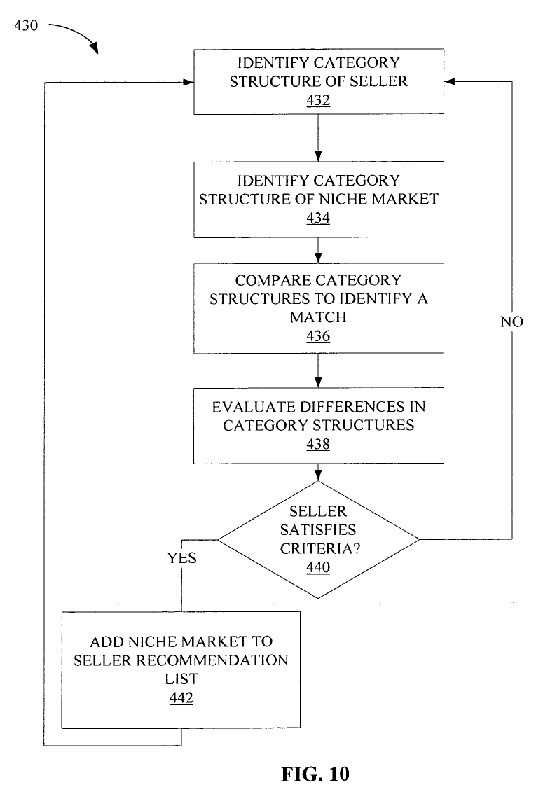

FIG. 10 is a flow diagram illustrating a method for matching seller category structures to niche market category structures, according to an example embodiment. The method 430 may be used for matching the seller category structure to the niche market category structure. As illustrated, the method 430 includes activities to identify at 432 the category structure associated with the seller. This involves identification of the various connections and hierarchical structure from each product through a leaf category to higher-level categories within a metacategory. Further, the method 430 includes identifying at 434 a category structure of the niche market. A comparison is made at 436 of the category structures associated with the seller and the niche market to identify a match in the structures. The method 430 then includes evaluating at 438 any differences in the category structures. A determination is made at decisional operation 440 whether the seller satisfies any of a variety of criteria. If so, the method 430 includes adding, at 442, the niche market to the seller recommendation list. If decisional operation 440 evaluates to no, the method 430 includes returning to 432 to evaluate structures associated with another seller.

When disqualified, such as at decision 440, a seller is filtered out of the process. The qualification criterion is intended to determine a high volume seller, and thus considers the focus of each seller's inventory. The method 430 includes checking for positive transactions to qualify a seller. In other words, the niche market information is to be applied to high volume sellers. Various techniques may be employed to further determine an optimum number of sellers to take advantage of the niche market information.

The niche market information may further be used to drive advertising and product informational pages, so as to assist in development of the new niche market. Various techniques then allow sellers, ecommerce business, and others involved in meeting the demands of consumption to better satisfy customers and provide efficient new market entries.

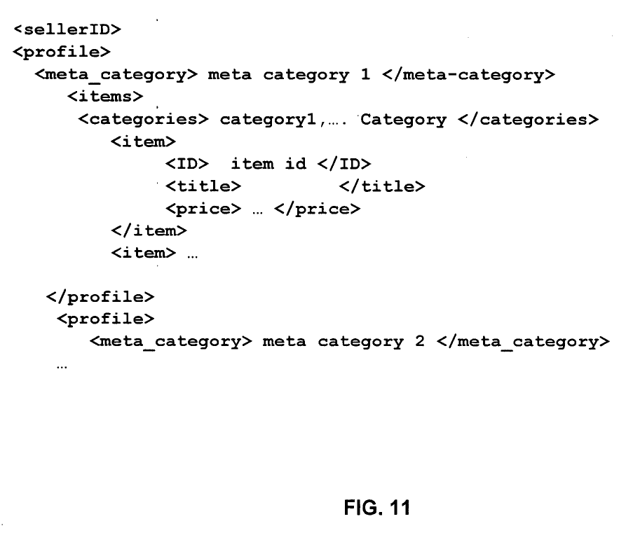

An example of a technique for identifying a niche market and sellers for application of the niche market is illustrated in FIGS. 11 to 13. The illustrated example is associated with direct seller merchandising, wherein a niche market item recommendation set is created for selected sellers. The direct seller merchandising is achieved by seller profiling and seller category matching.

In the seller profiling processing, for each seller identification (ID), a set of N completed items associated with a seller ID is retrieved, where N comprises a positive integer. The items are then grouped under the appropriate metacategories. One seller profile is created for each metacategory. For example, for a seller that sells products in the Health & Beauty metacategory and also in the Home & Garden metacategory, two profiles are created with at least one set of sample items for each metacategory. FIG. 11 illustrates a category structure for a seller profile, as written in XML notation. The subcategories are indicated by the indentation of lines in the code.

FIG. 12 provides a graphical illustration of seller category matching, wherein niche market item sets are mapped to the category hierarchy of the target metacategory. As illustrated, the metacategory is Health & Beauty, with a child node of “skin care.” Further, under the skin care category are further child nodes for “night cream” as well as “eye creams & gels.” Specific products are then included or identified by the lower level child nodes. The example illustrated in FIG. 12 is of a seller category structure.

The niche market items also have a category structure. Each niche market item is identified in a specific location of the category structure where the items will result in optimized sale of the items. The niche market items associated with categories of the niche market category structure are matched to categories in the seller profile, or in other words, the seller category structure.

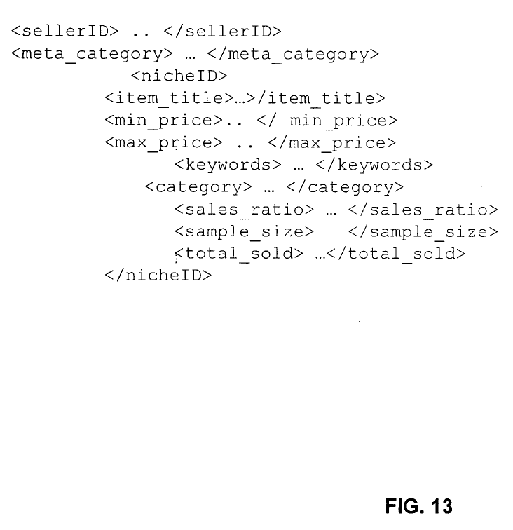

Seller matching methods include comparing the seller category structure to the niche market item category. The result of the seller matching is illustrated in FIG. 13, wherein XML notation is used to provide a niche market item recommendation set structure. The structure provides an example of how such information is presented within one embodiment.

In another example, a category-based matching identifies a seller that is currently selling cream products with a title of “Gerlain” in a “day creams” category, which is a child of a “skin care” category (not shown). A seller matching method includes matching the seller category structure, included in the seller profile, with the niche market items sets in the category of day creams, and then matches to sibling categories of night cream and eye creams & gels. The seller may be alerted to a potential of high successful sales ratio or a high sales price of a specific product. In the illustrated example of FIG. 12, products include Gerlain Issima creams, Vichy Normaderm night creams and Vichy Normaderm eye gel.

Additional embodiments may implement other category structures and hierarchies. For example, techniques to identify niche markets are not limited to a tree organizational structure, but may be applied to other organizational techniques. In one embodiment, the category items are stored in a relational database according to a relationship definition or scheme. The seller profiling method for such an example is enabled to take advantage of the relationships within the niche market structure for comparison to the seller product structure. In one embodiment, the category structure corresponds to the structure and organization used for presentation as part of a user interface, such as for presentation of an ecommerce catalog.

The category hierarchy can be used in a variety of ways. For example, the niche market item recommendations may be sorted according to the type and degree of separation of the categories in the category structure. The distance between items, such as items in sibling categories, may be a measure of relatedness of category structures. Similarly, the distance may be measured between an item and the corresponding metacategory. Various embodiments may apply a combination of techniques discussed herein.

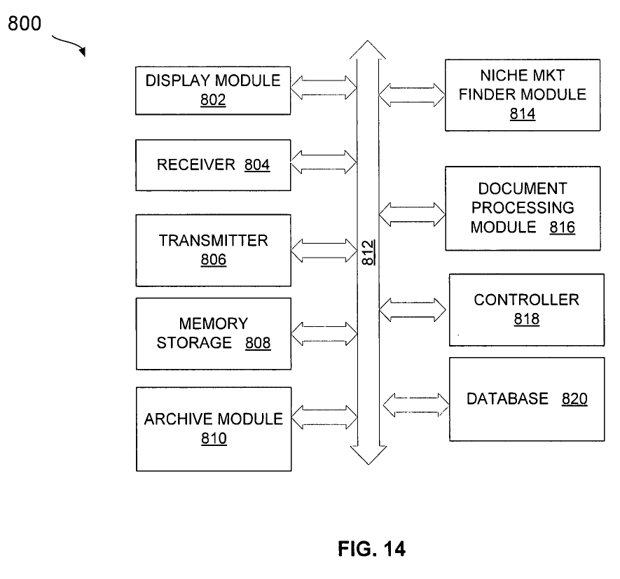

Various techniques for finding a new niche market and using the information may be implemented in a computing device, a networked server, or may be provided as machine-readable medium. FIG. 14 is a block diagram of a computing device 800, according to an example embodiment, for implementing a niche finder method according to an example embodiment. Within the computing device 800 a display module 802 controls display of information to a user. A receiver 804 and transmitter 806 allow the computing device 800 to communicate within a communication network (not shown). The display module 802 of computing device 800 is further to display information associated with query profiles, as well as to display information associated with items selected during performance of activities by the gap analyzer 202, and performance of activities by the query-item mapping engine 222. Further, the display module 802 may further be to display information associated with items found related to items selected for evaluation during a niche market finding method.

Data and information are archived by archive module 810 and is stored in memory storage 808. A communication bus 812 provides communication within computing device 800. As described herein, a niche market finder module 814 implements methods and techniques for identifying a niche market and then mapping to items. The niche market finder module 814 operates in collaboration with the document processing module 816. Further, a controller 818 is used to control operations within the computing device 800, wherein data is stored in database 820, which may be dedicated to a purpose, such as niche market and item data, or may be a shared database for multiple purposes.

The functions of the various modules and components of computing device 800 may be implemented in software, firmware, hardware, an Application Specific Integrated Circuit (ASIC) or combination thereof. The database 820 may store information specific to the computing device 800, where the computing device 800 sends the information to a networked ecommerce service for further analysis.

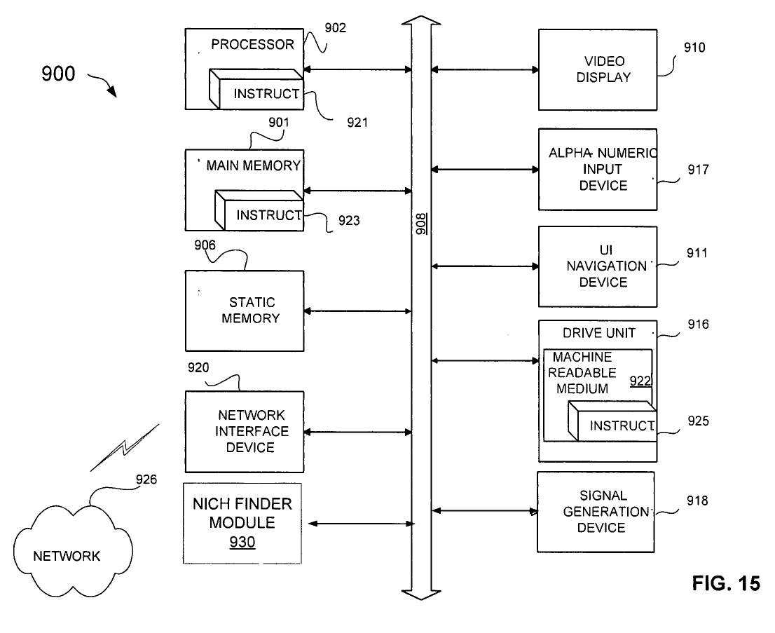

FIG. 15 is a block diagram of a system for implementing a niche market finder method according to an example embodiment. A specific machine may be implemented in the form of computer system 900, within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU)), which includes instructions 921 for operations and functions performed within and by the computer system 900. Further, a main memory unit 901 includes instructions 923 for storage in and control of main memory 901. A static memory 906 further is provided. wherein the modules within computer system 900 communicate with each other via a bus 908.

The computer system 900 may further include a video display unit 910 (e.g., a Liquid Crystal Display (LCD) or a Cathode Ray Tube (CRT)). The computer system 900 also includes an alphanumeric input device 917 (e.g., a keyboard), a user interface (UI) navigation device 911 (e.g., a mouse), a disk drive unit 916, a signal generation device 918 (e.g., a speaker) and a network interface device 920. The disk drive unit 916 further includes machine readable medium 922 having instructions 925 for storing and controlling the machine readable medium 922.

Additionally, the computer system 900 includes a niche market finder module 930 implementing functions to retrieve and store information related to sales of products, as well as information related to sellers. The functions further identify a niche market by analysis of the supply and demand for the various products and items retrieved. The niche market finder module 930 also functions to identify sellers for identified niche markets. The niche market finder module 930 may implement any of the methods, functions, apparatus, and processing discussed herein. The niche market finder module 930 transforms sales data and other sales-related information into niche market indicators, as well as seller indicators. In one embodiment, niche market indicators are reflected in a list of products within the niche market, and seller indicators are reflected in a list of sellers to facilitate the niche market.

Certain embodiments are described herein as including logic or a number of components, modules, or mechanisms. A component may be any tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component may be implemented mechanically or electronically. For example, a component may comprise dedicated circuitry or logic permanently configured (e.g., as a special-purpose processor) to perform certain operations. A component may also comprise programmable logic or circuitry (e.g., as encompassed within a general-purpose processor or other programmable processor) temporarily configured by software to perform certain operations. It may be appreciated that the decision to implement a component mechanically, in dedicated and permanently configured circuitry, or in temporarily configured circuitry (e.g., configured by software) may be driven by cost and time considerations.

Accordingly, the term “component” may be understood to encompass a tangible entity, be that an entity physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiples of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may, at a later time, access the memory device to retrieve and process the stored output. Components may also initiate communications with input or output devices, and can operate on a resource (e.g., a collection of information).

Example embodiments may be implemented in digital electronic circuitry, or in computer hardware, firmware, software, or in combinations of these. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network. In example embodiments, operations may be performed by one or more programmable processors executing a computer program to perform functions by operating on input data and generating output. Method operations can also be performed by, and apparatus of example embodiments may be implemented as, special purpose logic circuitry, e.g., as a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers having a client-server relationship to each other. In embodiments deploying a programmable computing system, it may be appreciated that both hardware and software architectures require consideration. Specifically, it may be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Continuing with FIG. 15, the machine-readable medium 922 of disk drive unit 916 stores one or more sets of instructions 925 and data structures (e.g., software) embodying or utilized by any one or more of the methodologies or functions described herein. The software may also reside, completely or at least partially, within the main memory 901 and/or within the processor 902 during execution thereof by the computer system 900, the main memory 901 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium capable of storing, encoding or carrying instructions for execution by the machine and that cause the machine to perform any one or more of the methodologies presented herein or capable of storing, encoding or carrying data structures utilized by or associated with such instructions. The term “machine-readable medium” shall accordingly be taken to include, but not be limited to, tangible media, such as solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions used within computer system 900 may further be transmitted or received over a communications network 926 using a transmission medium. The instructions, and other information, may be transmitted using the network interface device 920 and any one of a number of well-known transfer protocols (e.g., HTTP). Examples of communication networks include a local area network (“(LAN”), a wide area network (“(WAN”), the Internet, mobile telephone networks, Plain Old Telephone (POTS) networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible medium to facilitate communication of such software.

In some embodiments, the described methods may be implemented using one of a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology or a variety of technologies. The example three-tier architecture, and the technologies through which it is implemented, may be realized on one or more computer systems operating, for example, as a standalone system, or organized in a server-client, peer-to-peer, distributed, or some other suitable configuration. Further, these three tiers may be distributed between more than one computer systems as various components.

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

Some example embodiments may include remote procedure calls being used to implement one or more of the above described components across a distributed programming environment as distributed computing components. For example, an interface component (e.g., an interface tier) may form part of a first computer system remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

Example embodiments may use the OSI model or TCP/IP protocol stack model for defining the protocols used by a network to transmit data. In applying these models, a system of data transmission between a server and client, or between peer computer systems, may, for example, include five layers comprising: an application layer, a transport layer, a network layer, a data link layer, and a physical layer. In the case of software for instantiating or configuring components having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally Asynchronous Transfer Mode (ATM), Synchronous Network Architecture (SNA), Serial Data Interface (SDI), or some other suitable protocol. These networks may be organized within a variety of topologies (e.g., a star topology), or structures.

Although an embodiment has been described with reference to specific example embodiments, it may be evident that various modifications and changes may be made to these embodiments without departing from the broader spirit and scope of the present discussion. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it may be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of ordinary skill in the art upon reviewing the above description.

What is claimed is:

1. A computer-implemented method for a data processing system, comprising using at least one processor to:
receive a first number of search queries, each of the first number of search queries having a first search term;
generate a second number of search results responsive to receiving the first number of search queries, wherein each of the second number of search results corresponds to an item assigned to a category of the electronic data processing system;
select an evaluation item from the second number of search results based on a ratio of the first number of search queries to the second number of search results, the evaluation item assigned to a first category;
calculate a sales ratio for sales of the evaluation item and other items in the category over a first time period; and
select a first set of items in the first category having a sales ratio satisfying a sales ratio threshold.

2. The method of claim 1, wherein the first number represents demand for corresponding items and the second number represents supply of the corresponding items.

3. The method of claim 2, wherein the ratio of the first number of search queries to the second number of search results comprises a supply-to-demand gap.

4. The method of claim 1, wherein the first set of items corresponds to a niche market of items.

5. The method of claim 4, further comprising:
identifying a second set of items related to the first set of items, the second set of items corresponds to the niche market of items

6. The method of claim of claim 5, wherein the at least one measured value comprises a number of conversions for the items retrieved, wherein a conversion corresponds to a purchase transaction.

7. The method of claim 5, further comprising:
determining a number of available items in the second set of items; and
identifying a third set of items from the second set of items based on the number of available items, the third set of items comprising those items having a number of available items below a threshold value.

8. The method of claim 1, further comprising:
initiating a computing session; and
evaluating session logs associated with the first number of search queries to locate at least one measured value to identify demand for the items.

9. The method of claim 1, further comprising generating a query profile using the first set of items.

10. A computer system, comprising:
a gap analyzer unit to analyze data in an electronic data processing system by receiving a first number of search queries, each of the first number of search queries having a first search term, generating a second number of search results in response to the first number of search queries, wherein each of the second number of results corresponds to an item assigned to a category of the electronic data processing system, and selecting an evaluation item of the second number of search results based on a ratio of the first number of search queries to the second number of search results, the evaluation item assigned to a first category; and
a query item mapping engine to calculate a sales ratio for sales of the at least one item and other items in the category over a first time period, and to select a first set of items in the first category having a sales ratio satisfying a sales ratio threshold.

11. The computer system of claim 10, wherein the gap analyzer unit is further to receive session log information related to operation of the electronic data processing system.

12. The computer system of claim 11, wherein the query item mapping engine is further to receive transaction data related to operation of the electronic data processing system.

13. The computer system of claim 11, wherein the query item mapping engine is further to:
identify a second set of items which are similar to the first set of items, the second set of items corresponds to the niche market of items, the second set of items corresponds to the niche market of items;
determine a number of available items in the second set of items; and
identify a third set of items from the second set of items based on the number of available items.

14. The computer system of claim 13, wherein the query item mapping engine is further to:
identify the second set of items using keyword analysis; and
filter the second set of items as a function of demand.

15. The computer system of claim 14, wherein the query item mapping engine is further to:
identify a second category, wherein the second category is a parent of the first category; and
identify at least one leaf category of the second category, wherein evaluation item of the second set of items is in the at least one leaf category.

16. The computer system of claim 15, wherein the first number represents demand for corresponding items and the second number represents supply of the corresponding items.

17. The computer system of claim 16, wherein the electronic data processing system comprises an auction-based system.

18. The computer system of claim 10, wherein the first set of items corresponds to a niche market of items.

19. The computer system of claim 10, further comprising a display module for displaying information associated with the first set of items in the first category.

20. A machine-readable medium comprising instructions, which, when implemented by one or more machines, cause the one or more machines to perform the following operations:
receive a first number of search queries, each of the first number of search queries having a first search term;
generate a second number of search results in response to the first number of search queries, wherein each of the second number of results corresponds to an item assigned to a category of the electronic data processing system;
select evaluation item of the second number of search results based on a ratio of the first number of search queries to the second number of search results, the evaluation item assigned to a first category;
calculate a sales ratio for sales of the evaluation item and other items in the category over a first time period; and
select a first set of items in the first category having a sales ratio satisfying a sales ratio threshold.
